(19) United States
(12) Patent Application Publication
(10) Pub. No.: US 2013/0132430 A1
(43) Pub. Date: May 23, 2013

(54) Location Based Sales System

(71) Applicants: David C. Platt, Morrison, CO (US); MKichael Esposito, Lakewood, CO (US); Ram Dash, Parker, CO (US)

(72) Inventors: David C. Platt, Morrison, CO (US); MKichael Esposito, Lakewood, CO (US); Ram Dash, Parker, CO (US)

(21) Appl. No.: 13/304,296

(22) Filed: Nov. 23, 2011

(51) Int. Cl. G06F 17/30

(52) U.S. Cl. 707/770; 707/E17.018

(57) ABSTRACT

A location-based sales system includes a non geographically based information set with non-geographical based input characteristics that are from online classifieds for goods and services. Further included is a geographically based database with geographically based input attributes sets, wherein each set is associated with each of the online classifieds, each set includes geographic parameters. In addition, a query component based upon a buyer initiated search for the goods or services includes a geographic tag for the buyer. Also included are programs having instructions for executing the buyer initiated search in the information set and outputting a search result that matches the buyer initiated search, plus instructions to map a proximate path as between the buyer geographic tag and each one of the attribute sets associated with the search result group, wherein operationally the buyer can view goods or services search results that include geographic mapping for each specific search result.

### TECHNICAL FIELD

The present invention generally relates to a system for location based sales as between a seller and buyer. More particularly, the present invention is an on-line based and location based sales system, that includes various software components that work together to form an aggregated list of sales items across multiple listing sites that offer goods and services for sale. The present invention system makes the seller goods and services available in a single list and provides these lists on the web and over mobile devices, wherein the mobile devices are enabled with a global positioning system that alerts and provides buyers with their desired goods and services that they have searched for having real time geographic proximity alerts.

### BACKGROUND OF INVENTION

The need for efficient and effective communication between a seller and buyer is paramount for both the seller and buyer to find one another in real time for their mutual benefit. With the advent of internet based buying and selling becoming more established and widely accepted, and further with these internet sales transactions becoming more secure and reliable, has given an increase to buyer and seller confidence in using the internet for transactions. Further, one of the benefits of the internet as it has allowed individuals who want to buy and sell goods and services online, a venue or medium to find a very wide geographical distribution of other potential buyers and sellers to do transactions with, plus in addition to conventional larger merchants and large-scale buyers using the internet also. As the three premier examples would be AMAZON, EBAY, and CRAIGSLIST as being very popular sites for conducting seller and buyer transactions, furthermore especially in the case of CRAIGSLIST which is divided into major metropolitan areas, in other words various cities that puts out a listing of items for sale in broad-based categories such as furniture, electronics, etc., that is simply a database listing of the most recent listings on top of the list, with for instance the furniture for sale items existing in a random array of various locations, prices, types, qualities, and so forth. Thus, it would be desirable for the CRAIGSLIST listing to have a sorting of items for sale based on a specific location further using a global positioning system to determine the relative proximity of a particular item for sale to where the buyer is located, plus also given that there's been a recent upsurge in mobile devices that have global positioning system capabilities would facilitate this added convenience. Thus there is an opportunity to integrate specific location-based goods and services for sale relative between the buyer and seller's locations currently on CRAIGSLIST, for instance currently on CRAIGSLIST when the seller lists an item for sale, typically the sole means of contact from a potential buyer is a coded e-mail address which gives the seller a high degree of an anonymous identity. Wherein the seller would typically not disclose their phone numbers or location until they knew that they had a serious buyer, as there can be safety concerns and security concerns on the part of the seller, especially if they're selling a high value item and having contact with a potential buyer that they don't know. Thus the seller can ease their safety and security concerns if the seller has control over whether their items location can be disclosed and at what times and days to allow a potential buyer to come view their items for sale.

Looking at the prior art in this area starting with U.S. Pat. No. 7,840,558 to Wiseman, et al., disclosed is a geo-tagged based listing service and mapping engine that facilitates searching for items offered for sale or otherwise in an online classifieds environment. The system and method in Wiseman involves allowing a user to search for such items according to the item's location or geo-tag information as a priority, wherein the geo-tag information for each item can be approximate such as the city, state, or zip code, or more specific such as the street address where the item is located. In Wiseman the amount of geo-tag information disclosed to any other user can depend on the type of item being offered with one or more geo-tagged items being returned in response to a query. The items in Wiseman can be returned in a list or a map format wherein the items can be pinpointed according to their locations. The map of the area around and near the item's location in Wiseman can provide useful information to the user to facilitate determining which item(s) to pursue. Wiseman makes the location parameter the primary item search filter, wherein accurate location information relative to the item is determined by the seller, thus the seller could give out very generalized item location information, such as just a city of state-due to seller security and safety concerns. A further purpose of Wiseman is to give the general tenor of the surrounding neighborhood, say if someone was interested in a vacation home—they would want to know how close are major shopping areas and the like. Thus in Wiseman, the location is primary as the user initial inquiry is processed across a set of geo-tagged items wherein the items themselves are a secondary subset of location for use by the user, also included are user discarded items and an unopened item monitor both that inform the purveyor of the discarded or unopened items the reason of why their items were discarded or unopened.

Continuing in the prior art in U.S. Pat. No. 7,403,939 to Virdy disclosed is a system for resolving queries based on automatic determination of requestor geographic location. In Virdy, resolving a query term includes receiving at least one query term from a requestor and determining a geographic location of the requestor, the geographic location of the requestor may be determined by accessing an electronic information store containing a requestor profile including geographic information about the requestor, wherein the requestor profile is used by more than one program. The query term in Virdy is resolved against electronic information within at least one electronic information store to determine whether one or more matches exist and a result is generated that accounts for the geographic location of the requestor. Thus in Virdy, generalized search results are sorted to be proximate to the search inquirer again based primarily of geographic location rather than subject matter relevancy much like Wiseman.

Further, in the prior art in U.S. Pat. No. 7,330,112 to Emigh, et al., disclosed is a method for logging items encountered by a mobile device, that includes automatically detecting an item; wherein detecting the item occurs in an uncontrolled environment; extracting an identity; wherein the identity is associated with the item; logging an encounter; wherein the encounter includes the identity; and deleting the encounter after a predetermined period of time has elapsed, wherein the encounter is not marked as relevant. As a prime example in Emigh, the item is a license plate, wherein the license plate data is compared to a database to alert a user or store in a separate database for later viewing by a user if the license plate is on a list of interest, thus the item is random with specific information about the item retrieved if available.

Next, in the prior art in United States Patent Application Publication Number 2006/0224662 to Richardson, et al., disclosed is an associating supplementary information system with network-based content locations. The subject invention system in Richardson leverages a locating means, such as, for example, internet IP addresses to provide supplementary information based on the location of network content, this allows additional information to be disseminated with the search result content without requiring the content itself to be modified to contain the supplementary information. By providing locating means in Richardson, with association-based supplementary information, the subject invention permits supplementary information such as, for example, advertising, notes, chats, and the like to be relayed to a user along with the desired unaltered content such as, for example, with a web page. In one instance of the subject invention in Richardson, advertisements are associated with internet URLs, allowing advertisers to purchase associations that they deem beneficial to their businesses for a search engine. In another instance of Richardson, a function of the locating means is utilized to provide a set of locations to associate supplementary information with. Thus in Richardson, location associated content can be served up with the primary search results and further with search subject matter content associated filtering, location, and search subject matter content association can be served up with the search results to generate added search revenue.

Also in the prior art in U.S. Pat. No. 7,920,878 to Clipsham, disclosed is a mobile computing device that includes a location based reminder application to set a target location for a reminder item, the target location comprising a location other than a current location for the mobile computing device, and to provide a location based reminder for the reminder item when the current location matches the target location. Further, in Clipsham included is an attention manager coupled to the location based reminder application, the location based reminder application to receive an alarm message indicating that the current location matches the target location, and send an attention request message to the attention manager, with the attention manager providing an attention indicator.

What is needed is a system that can answer the question; I want to buy a guitar, how close is there one to me for sale? The system would include real-time searching capability for a selected good or service that is tagged with location data, wherein the system would search the internet for all possible options that fit via filtering within the user's criteria for good/service and location, wherein the system would have full functionality for desktop computers and mobile devices to enhance the system's functionality with good/service specifics plus location based specifics such as geographic routing from the user's home base plus hours and days available and the like for the location of the good/service.

### SUMMARY OF THE INVENTION

A location-based sales system that includes a non geographically based information set with a plurality of non-geographical based input characteristics that are selected from the group consisting essentially of online classifieds for goods and services that are created by at least one seller. Further included in the location-based sales system is a geographically based database including a plurality of geographically based input attributes sets, wherein each set is associated with each of the online classifieds, each set includes geographic parameters that are selected from the group consisting essentially of zip codes, street addresses, city names, county names, state names, and geographic feature descriptors. In addition, in the location-based sales system is a query component based upon a buyer initiated search for the goods or services that includes a geographic tag for the buyer, plus one or more processors, memory, one or more programs, wherein the one or more programs are stored in the memory and configured to be executed by the one or more processors. The one or more programs including instructions for executing the buyer initiated search in the information set and outputting a search result group that matches the buyer initiated search, wherein the group includes at least one specific search result. Also, instructions to map a proximate path as between the buyer geographic tag and each one of the attribute sets associated with the search result group, wherein operationally the buyer can view goods or services search results that include geographic mapping for each specific search result.

### BRIEF DESCRIPTION OF DRAWINGS

FIG. 1 shows a flowchart of the location based sales system being the logical overview, starting with a web application engine 180 that interfaces with the mobile web service and the consumer, i.e. buyer 75 and seller 60 website 155 which then subsequently interfaces with the internet, then diffusing into specific users of the location based sales system, that can include general web based clients, mobile applications, and listing websites such as CRAIGS LIST, and the like;

FIG. 2 shows a flowchart of the location based sales system portion from FIG. 1 in more detail being the location based sales system physical infrastructure that includes an n-tier application that includes a user interface, service, application, and database 205 layers that can be deployed on physical hardware infrastructure in a scalable way, wherein FIG. 2 represents an example of how the location based sales system could be deployed in a production environment;

FIG. 3 shows a flowchart of the location based sales system software components that show how the logical overview of the location based sales system from FIG. 1 is implemented via the FIG. 3 software components, noting that the software components track closely with the logical components as shown in FIG. 3, however the web application engine is broken down into business objects that provide all the business logic and most of the backend processing required by the web service, website, and a listing gator that provides all the communication and aggregation of seller and product information from multiple websites with such information from the internet, further a location based sales system database provides all the relational database transactional information required by the system;

FIG. 4 shows the location based sales system sample screen shot of the web-based login for the actors that include the buyer, seller, and the administrator, wherein the functional purpose is to allow a secure login to the location based sales system website;

FIG. 5 shows the location based sales system sample screenshot of the web-based login for the seller, with the function being to allow the seller access to the website to manage their account settings, wherein the seller's landing page and the seller settings provide functions to set parameters specific to the seller's general web experience and interaction with the special functionality offered by the location based sales system;

FIG. 6 shows the location based sales system sample screenshot for the input of the seller availability time settings that allow the seller to set the times when their products will be available to buyers via the global positioning system proximity alerts;

FIG. 7 shows the location based sales system sample screen shot where the seller can input tags to allow the seller to identify common tags used in their product listings across multiple web-based listing sites, operationally the tags allow the location based sales system to identify a seller's product when querying product listing agent content, such as in CRAIGSLIST, and then pull that data into the location based sales system and mobile services;

FIG. 8 shows the location based sales system sample screenshot for the buyer settings that operationally allows the buyer to manage their account settings, wherein the buyer is allowed to set parameters specific to buyers general with experience and interaction with the location based sales system;

FIG. 9 shows the location based sales system sample screenshot of the buyer settings where it is shown that the buyer radius or proximate path maximum distance setting allows the buyer to set their distance to a seller's a product location or a product geographic proximity alert on the buyer's global positioning system enabled local device;

FIG. 10 shows the location based sales system sample screenshot for the buyer wherein the buyer may create and manage their product searches on the website, further the buyer may create and save product searches in the system with products being searched across multiple listing websites, products that are found that match registered sellers in the system are presented in a consolidated list as shown, the items in the list are also tracked in the mobile application which provides the buyer with geographic proximity alerts to the buyer;

FIG. 11 shows the location based sales system sample screenshot wherein the buyer saved search may be edited;

FIG. 12 shows the location based sales system sample screenshot of the buyers listing gator wherein operationally multiple listing engines are searched for the buyers particular search with the combined the results in a single list, wherein the results are matched to sellers in the system to provide geographic location information to the buyer, thus the search results represent consolidated product search results across multiple listings on the web, the results are then cross-referenced by sellers registered in the location based sales system, this list is available on both the web and mobile applications, the mobile applications provide the additional functionality of the geographic proximity alerts for products to the buyer;

FIG. 13 shows the location based sales system sample screenshot of the web service interface between the mobile application and the web application engine, wherein operationally this interface provides an interface to applications that wish to utilize the location based sales system, which includes the mobile application;

FIG. 14 shows the location based sales system sample screenshot of the buyer or seller mobile device login, wherein the location based sales system can utilize multiple types of mobile applications including IPHONE, ANDROID, WINDOWS, BLACKBERRY, and the like;

FIG. 15 shows the location based sales system sample screenshot on the mobile device for the buyer to access and manage their account settings;

FIG. 16 shows the location based sales system sample screenshot that shows where the buyer can have access to and manage their saved searches, wherein what is showing it is the buyer's consolidated product search results that are across multiple listings on the web, the results are cross-referenced by sellers registered in the location based sales system, this list is available on both the web and the mobile application device, wherein the mobile application device also provides the added functionality of the geographic proximity alerts for products to the buyer;

FIG. 17 shows the location based sales system sample screenshot of a global positioning system map view allowing the buyer to view real-time results and geographic location information of their search results, when a buyer enters a range of seller products, the buyer notified of the geographic proximity of the products, wherein the red balloons indicate the product locations;

FIG. 18 shows the location based sales system sample screenshot of the global positioning system map of FIG. 17 wherein the visual driving directions to a particular seller's location associated with the product found in the buyers research are shown;

FIG. 19 shows the location based sales system sample screenshot of the textual driving instructions to a seller's location associated with the product found in the buyers search that are associated with the visual driving instructions shown in FIG. 18;

FIG. 20 shows the location-based sales system sample screenshot that show the sellers ability to access the mobile device to manage their account settings for their products offered for sale;

FIG. 21 shows the location-based sales system sample screenshot of seller settings where the seller can set the times they will be available to sell their products for potential buyers via the global positioning system proximity alerts; and

FIG. 22 shows a location-based sales system sample screenshot of the administrator webpage wherein the administrator may manage the website, membership, and system operation components.

### REFERENCE NUMBERS IN DRAWINGS

50 Location-based sales system
55 Non-geographically-based information set
60 Seller
65 Settings array for seller 60
70 Online classifieds for goods and services
75 Buyer
80 Criterion arrangement for buyer 75
85 Proximate path maximum distance for buyer 75
90 Good type for buyer 75
95 Good price range for buyer 75
100 Good make for buyer 75
105 Good model for buyer 75
110 Year of good manufacture for buyer 75
115 Service type for buyer 75
120 Service price range for buyer 75
125 Service years in business for buyer 75
130 Service specific experience for buyer 75
135 Geographically-based database
140 Query component
145 Receiving a query from the buyer 75
150 Geographic tag for buyer 75
155 Website for buyer 75
160 Mobile device application for buyer 75
165 Processors
170 Memory
175 Programs
180 Web application engine
190 Business objects
200 Listing gator
205 Database
210 Instructions for executing buyer 75 initiated search
215 Priority of execution
220 Mapping engine utilizing global positioning services
225 Proximate path
230 Instructions to map the proximate path
235 Visual map
240 Perceptible indication on the visual map
245 Abbreviated information box
250 Detailed information box
255 Textual rendition of the proximate path
260 Access a credential protected non-geographically-based information set
265 Access a credential protected geographically-based database
270 Outputting at least one specific search result
275 Specific search result wherein buyer can view goods or services search results that include geographic mapping

### TERM DEFINITIONS

Web—consumer website—the consumer website is the marketing and membership management component of the system. Both buyers and sellers may sign up for the service, access service specific functions, manage payments, subscription, and other account information.

Mobile application—the mobile device is where the application enables the buyers to view the combined aggregate sales information from the listing website. Buyers may also access sellers locality information displayed via the mobile devices. Global positioning systems, mapping, and general web direction services and alerting the end users to a product offerings proximity location wise. Although the initial prototype system was designed for the IPHONE—any mobile device can utilize the system in those devices that are global positioning system enabled and can make use of the proximity alert system. Sellers may also manage basic account information in the system.

Web service—mobile consumer website—the mobile consumer web service is the interface between the web application engine and the mobile application. It serves as a broker of data between the mobile application and the web-based systems. It provides mobile device information to allow the buyers to find and locate products that they are looking for. In addition, it also provides account management information for both buyers and sellers to manage their accounts on the mobile device.

Web application engine—the web application engine is a component on the backend and manages basic web and data services for the system. It also connects the listing websites to collect information on the registered sellers product information. This information is aggregated and made searchable for buyers in the system.

Business objects—the business objects provide all the business logic and background processing required by the web service, website, and listing gator. It communicates to the system database for interaction and persistence.

Listing gator—this component provides authentication and aggregation of seller and product information from multiple websites on the internet.

The location-based sales system database—the system database provides all the relational database transactional information required by the system. It serves as the data repository for all transactional data in the location-based sales system.

Buyer—buyers are users of the service and are seeking to find products and/or services across multiple listing sites on the internet. Further, to display those results via the web and mobile devices. The mobile devices may provide global positioning system real-time location and mapping technology.

Seller—sellers are users of the service seeking to combine their products and/or services for multiple listing sites and make them available through mobile devices using global positioning systems real-time location and directional mapping technology.

Administrator—administrators are users of the service who administer site functions, security, and content.

### DETAILED DESCRIPTION

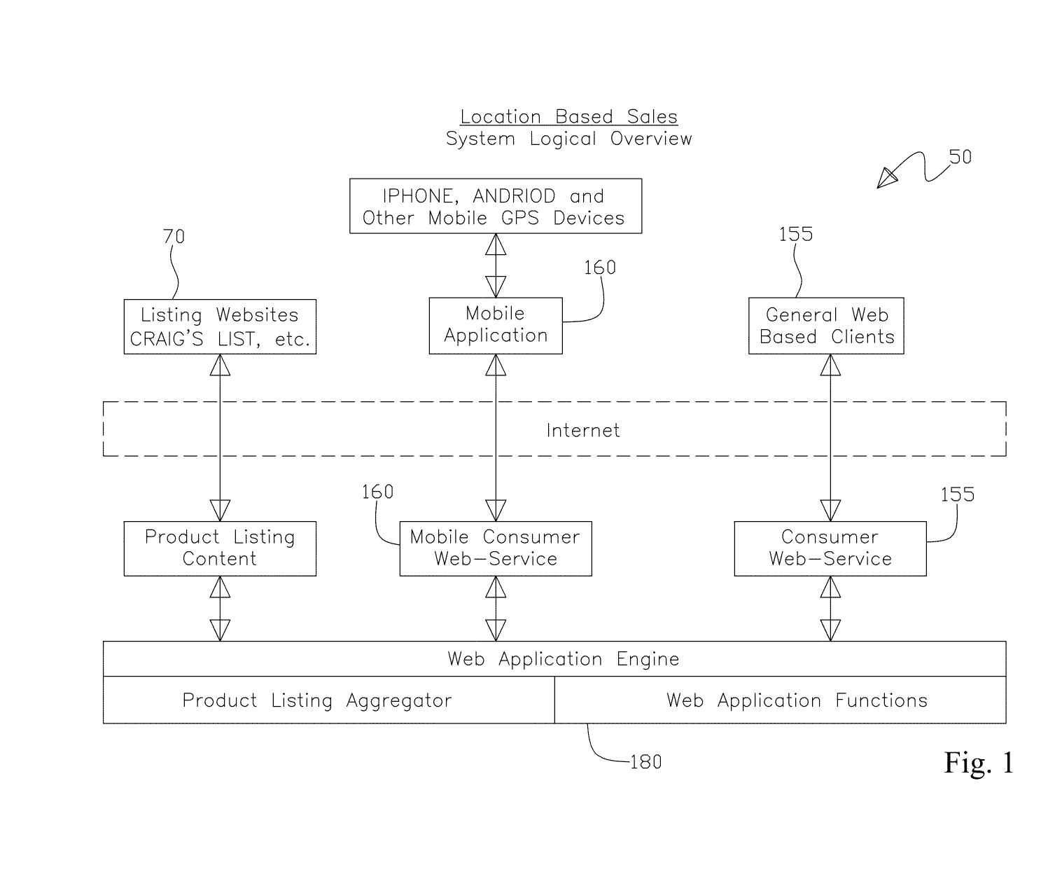

Initially referencing FIG. 1, a logical overview is provided for the location-based sales system 50, starting with listing websites 70, wherein the listing websites are providers on the internet of sales listing information. As examples for the listing websites 70 are CRAIGSLIST, newspaper want ads, EBAY, and the like, can provide any internet-based forum where product sales information is listed that can be exposed to buyers 75 for searches in the system, either from a desktop computer based system or mobile search devices 160. Looking at particular to the mobile application 160, is where the buyers 75 are able to view the combined or aggregated sales information 70 from the listing website 70. The mobile application 160 also allows the sellers 60 locality information 135 to be displayed via the mobile devices 160 global positioning system 220, including mapping 220 and general web direction services such as routing, textual instructions 255 for the routing, expected times, mileages, and the like.

Continuing to refer to FIG. 1, the buyer 75 and seller 60 website is the marketing and membership management component of the system. Both buyers 75 and sellers 60 may sign up for the service, and have access to service specific functions, manage payments 65, subscriptions, and other account information. Further, in FIG. 1 looking to the mobile consumer web service 160, the mobile consumer web services interface between a web application engine and the mobile application is shown. It serves as the broker of data between the mobile application 160 and web-based system. It provides the mobile device information 160 to allow the buyers 75 to find and locate products 70 that they are looking for. In addition, it also provides account information management information for both buyers 75 and sellers 60 to manage their accounts on the mobile device 160.

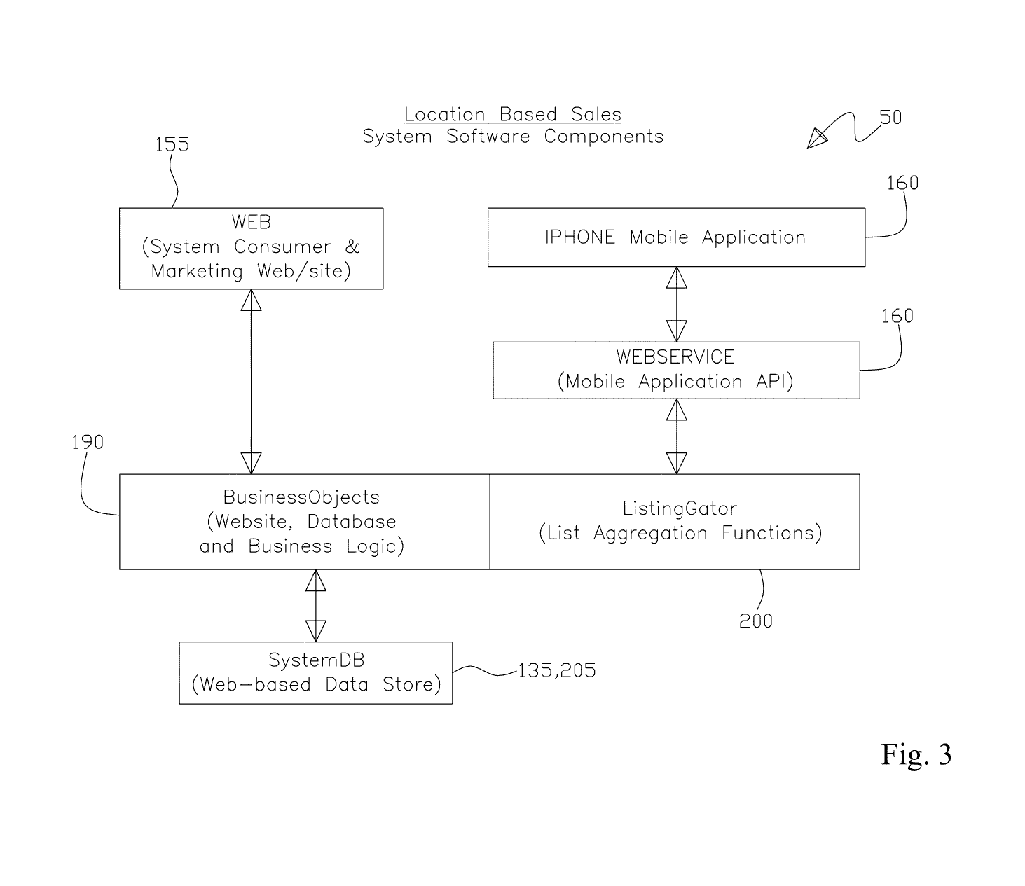

Further in FIG. 1, the web application engine is a component of the far backend of the system 50, that manages basic web and data services for the system 50. It also connects the listing websites to collect information and discover the seller 60 and product information 70 which aggregates to the buyers 75 in the location-based sales system 50. The location-based sales system 50 logical overview in FIG. 1 is implemented via the following software components as depicted in FIG. 3.

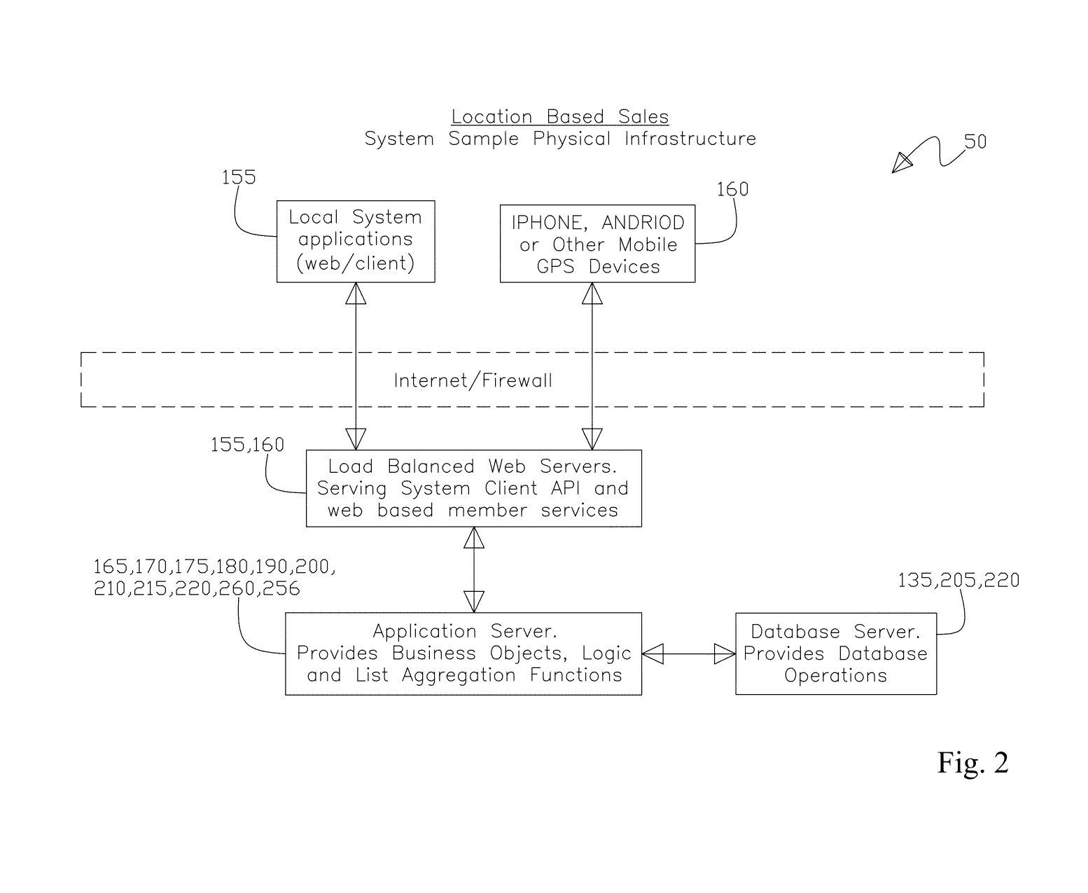

In referring to FIG. 2, the location-based sales system 50 is an n-tier application that includes the buyer 75, seller 60, and administrator interface, service, application, and database 205 layers that can be deployed on physical hardware and a scalable way. FIG. 3 represents an example of how the location-based sales system 50 could be deployed in a production environment.

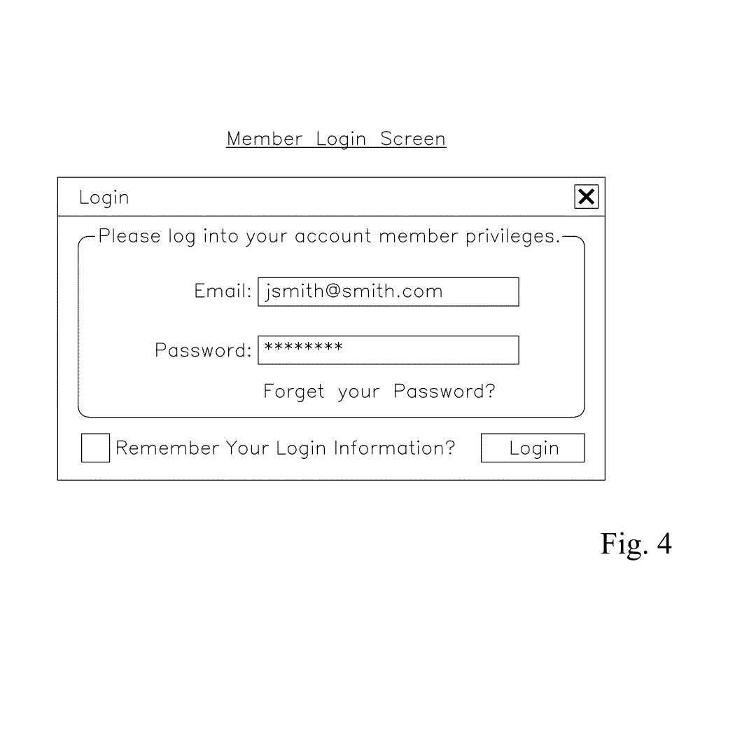

In referring to FIG. 3, the original software components track closely with the logical components as described in FIG. 1. However, the Web application engine is broken down into the following; starting with the business objects 190, wherein the business objects 190 provide all the business logic and most of the backend processing required by the web service and the website. The listing gator 200 provides all the communication and aggregation of seller 60 and product information 70 from multiple websites with the information on the internet. Looking at FIG. 4 shows the location based sales system 50 sample screen shot of the web-based login for the actors that include the buyer 75, seller 60, and the administrator, wherein the functional purpose is to allow a secure login to the location based sales system 50 website.

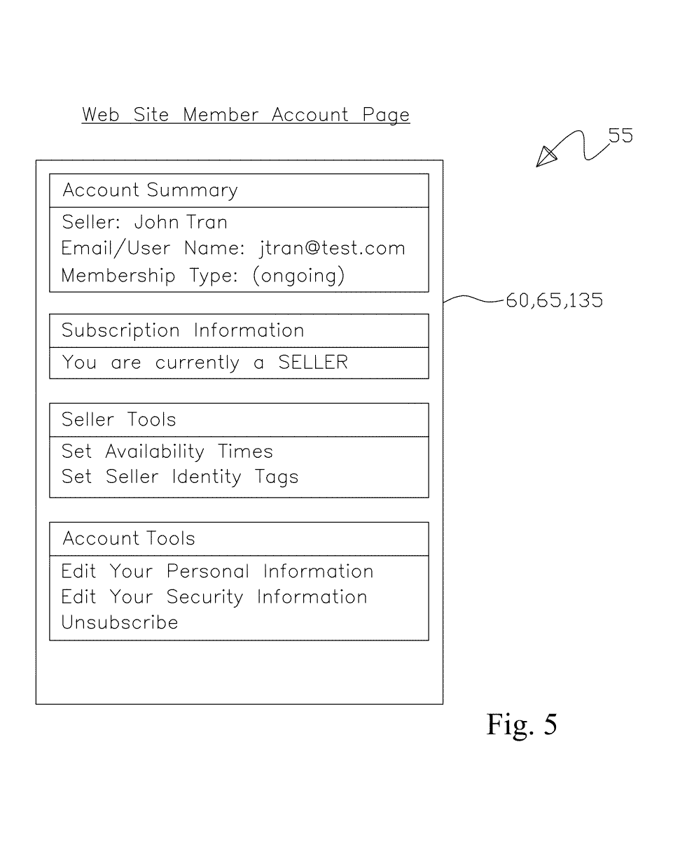

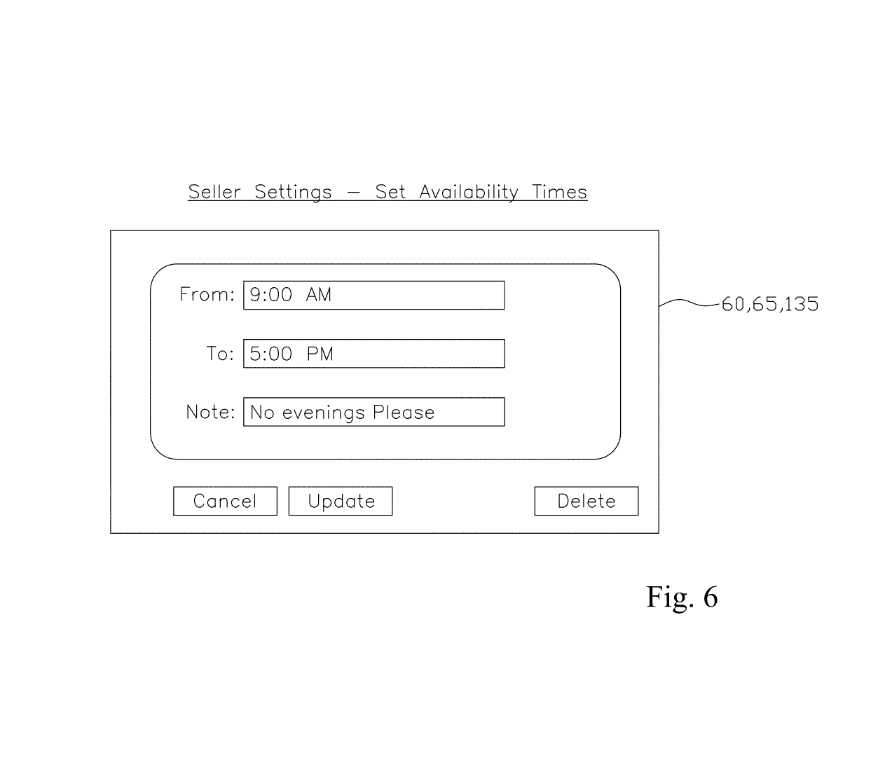

Continuing to FIG. 5, shows the location based sales system 50 sample screenshot of the web-based login for the seller 60, with the function being to allow the seller 60 access to the website to manage their account settings 65, wherein the seller's 60 landing page and seller 60 settings 65 provide functions to set parameters specific to the seller's 60 general web experience and interaction with the special functionality offered by the location based sales system 50. Next, FIG. 6 shows the location based sales system 50 sample screenshot for the input of the seller 60 availability time settings 65 that allow the seller 60 to set the times wherein that their products 70 will be available to buyers 75 via the global positioning system 220 proximity alerts.

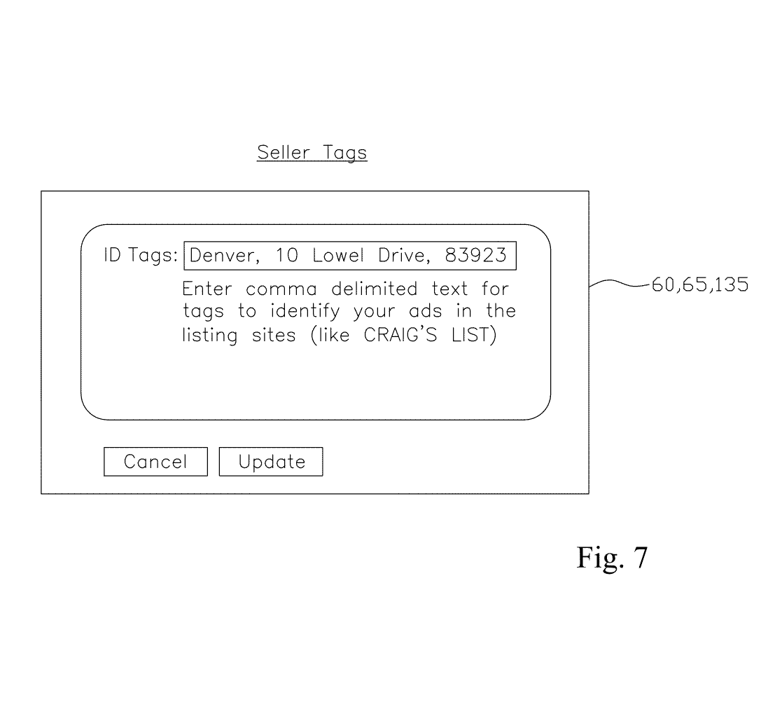

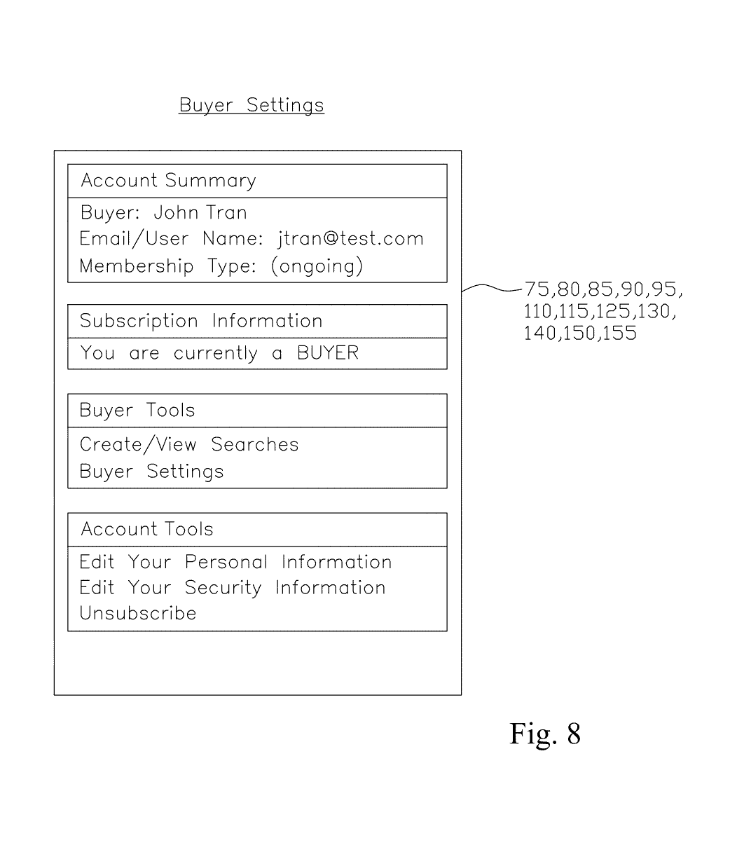

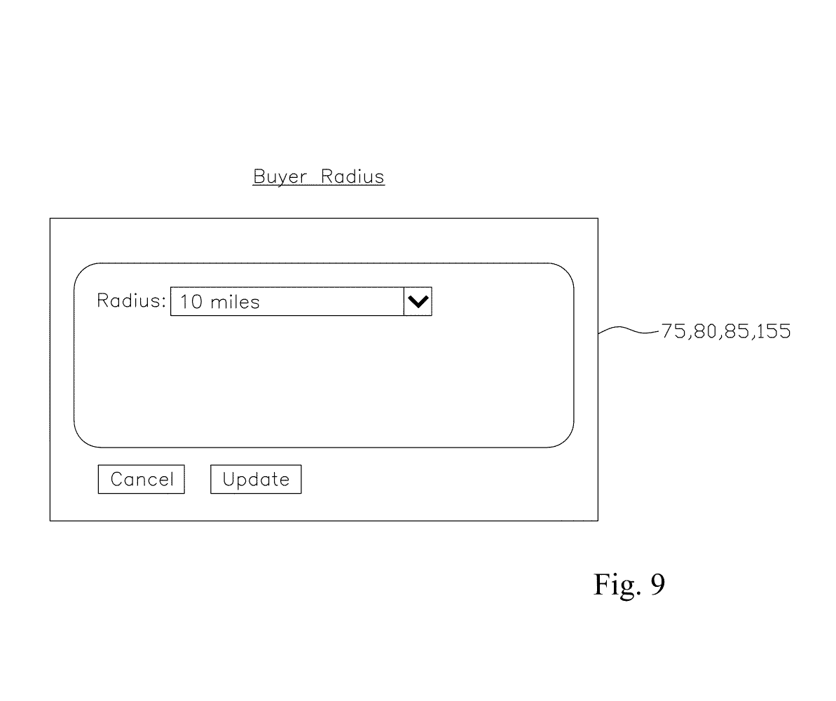

Further, FIG. 7 shows the location based sales system 50 sample screen shot when the seller 60 can input tags 65 to allow the seller 60 to identify common tags used in their product listings 70 across multiple web-based listing sites, operationally the tags allow the location based sales system 50 to identify a seller's 60 product 70 when querying 140 product listing agent content, such as in CRAIGSLIST 70, and then pull that data into the location based sales system 50 and mobile services 160. Next, FIG. 8 shows the location based sales system 50 sample screenshot for the buyer 75 settings that operationally allows the buyer 75 to manage their account settings 80, wherein the buyer 75 is allowed to set parameters specific to buyers 75 general experience and interaction with the location based sales system 50. Continuing, FIG. 9 shows the location based sales system 50 sample screenshot of the buyer 75 settings 80, shown is the buyer radius setting 85 or proximate path maximum distance setting 85 that allows the buyer 75 to set their distance 85 to a seller's 60 product 70 or a product 70 geographic proximity alert on the buyer's 75 global positioning system 220 enabled local device 160.

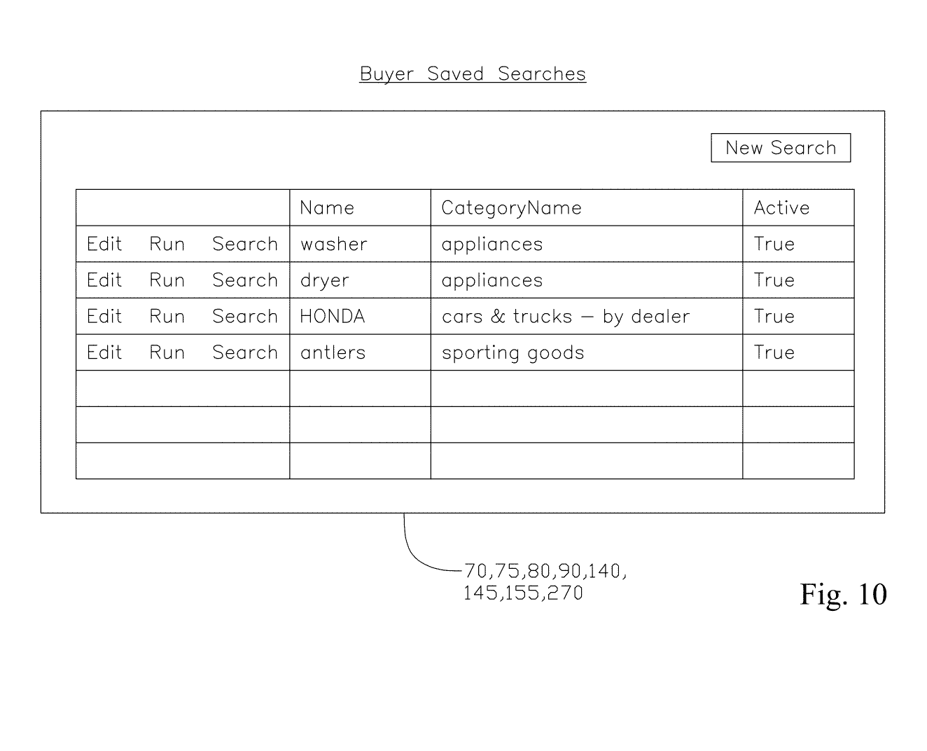

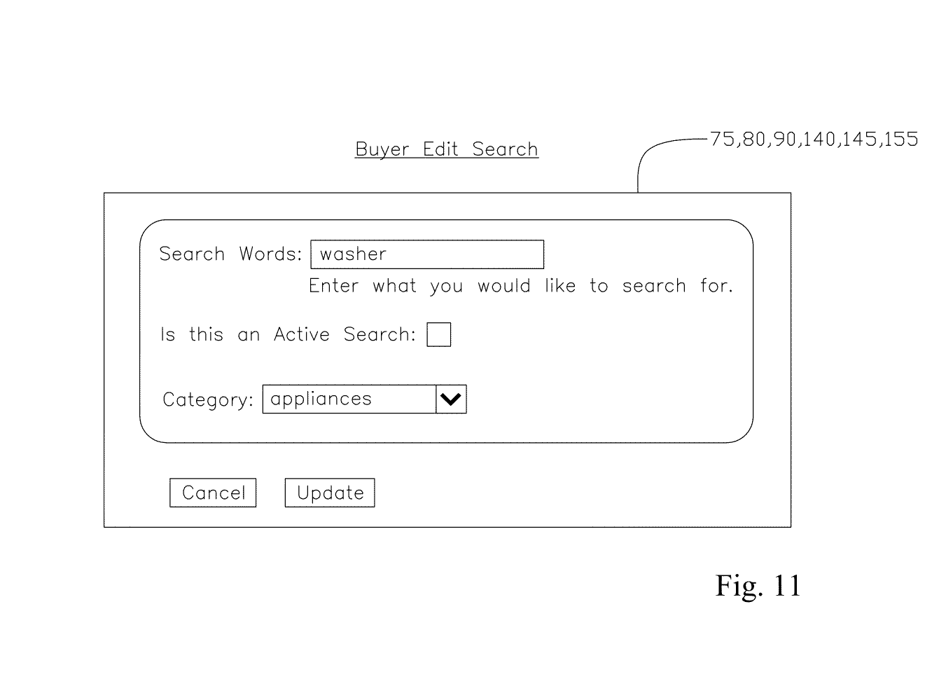

Next, FIG. 10 shows the location based sales system 50 sample screenshot for the buyer 75, wherein the buyer 75 may create and manage 80 their product searches on the website, further the buyer 75 may create and save product searches in the system 50 with products 70 being searched across multiple listing websites 70, wherein products 70 that are found that match registered sellers 60 in the system are presented in a consolidated list 270, 275 as shown. The items in the list in FIG. 10 are also tracked in the mobile application 160 which provides the buyer 75 with geographic proximity alerts 220 to the buyer 75. Further, FIG. 11 shows the location based sales system 50 sample screenshot wherein the buyer 75 saved search may be edited.

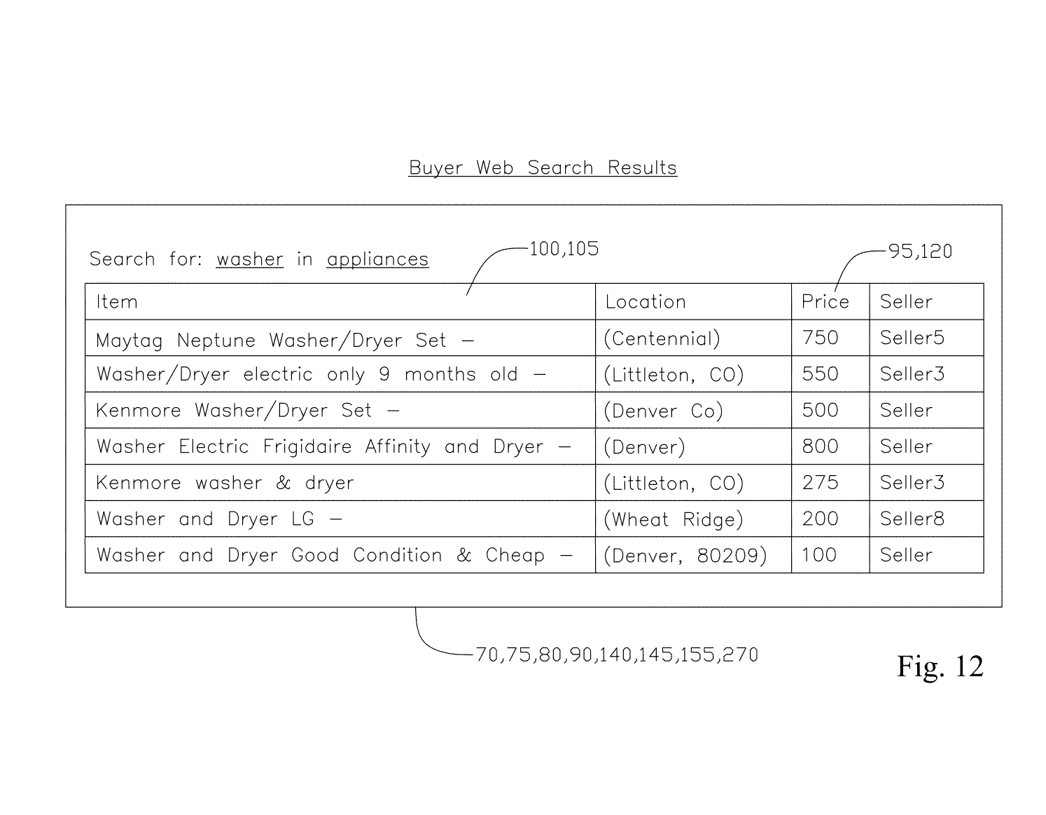

Moving onward, FIG. 12 shows the location based sales system 50 sample screenshot of the buyers 75 listing gator 200 wherein operationally multiple listing engines 70 are searched for the buyers 75 particular search 140, 145 and with the combined the results 270, 275 in a single list. Wherein the results are matched to sellers 60 in the system 50 to provide geographic location information 220 to the buyer 75, thus the search results represent consolidated product search results across multiple listings 70 on the web. The results are then cross-referenced by sellers 60 registered in the location based sales system 50, this list is available on both the web and mobile 160 applications, the mobile applications 160 provide the additional functionality of the geographic proximity alerts 220 for products to the buyer 75.

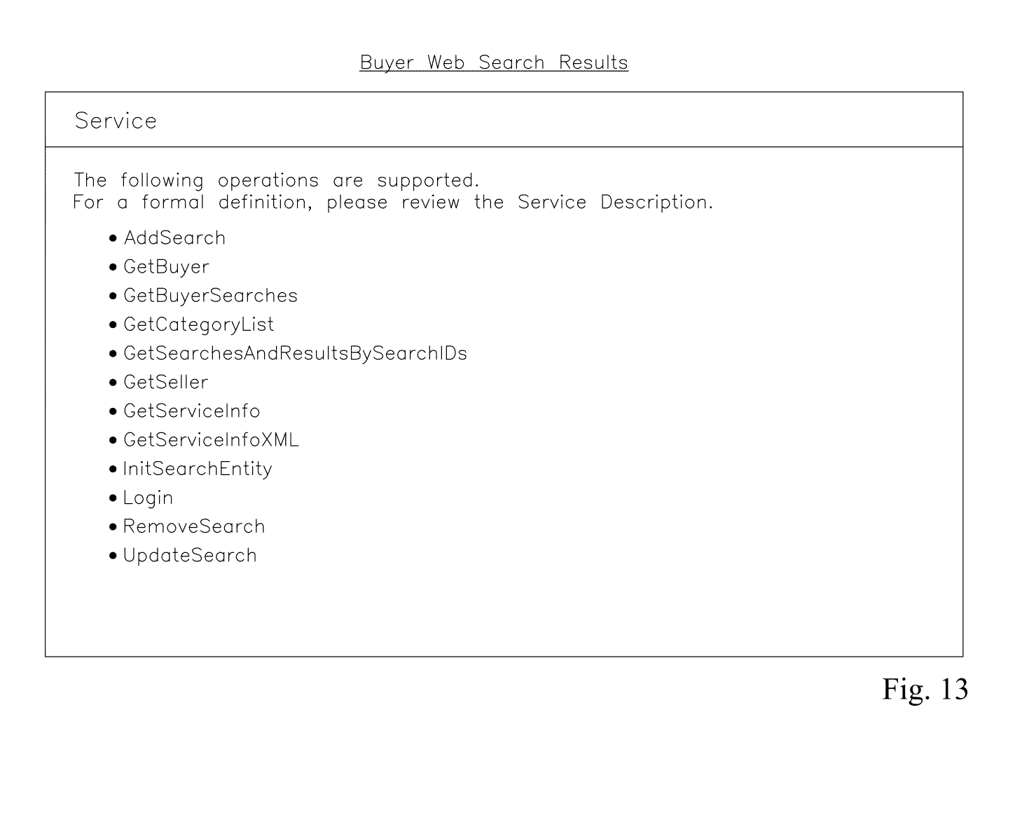

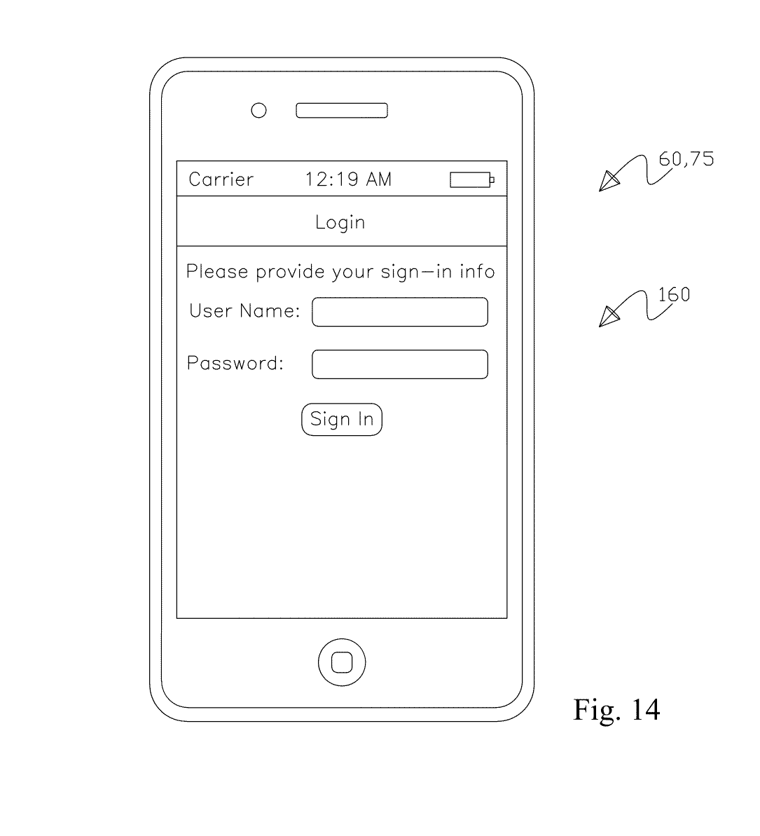

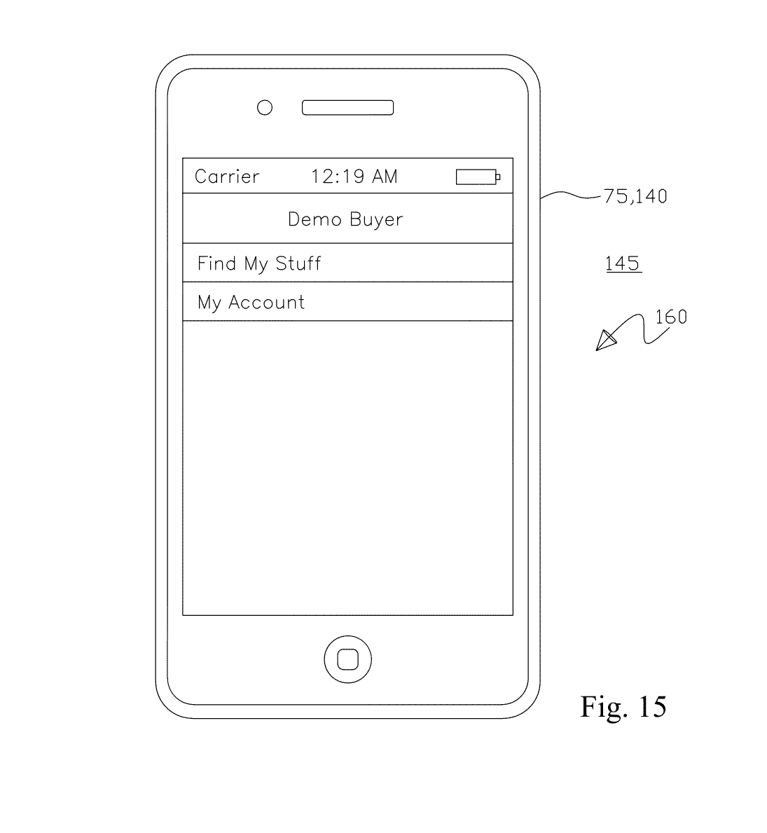

Further, FIG. 13 shows the location based sales system 50 sample screenshot of the web service interface between the mobile application 160 and the web application engine, wherein operationally this interface provides an interface to applications that wish to utilize the location based sales system 50, which includes the mobile application 160. Next, FIG. 14 shows the location based sales system 50 sample screenshot of the buyer 75 or seller 60 mobile device 160 login, wherein the location based sales system 50 can utilize multiple types of mobile applications 160 including IPHONE, ANDROID, WINDOWS, BLACKBERRY, and the like. Continuing, FIG. 15 shows the location based sales system 50 sample screenshot on the mobile device 160 for the buyer 75 to access and manage their account settings 80.

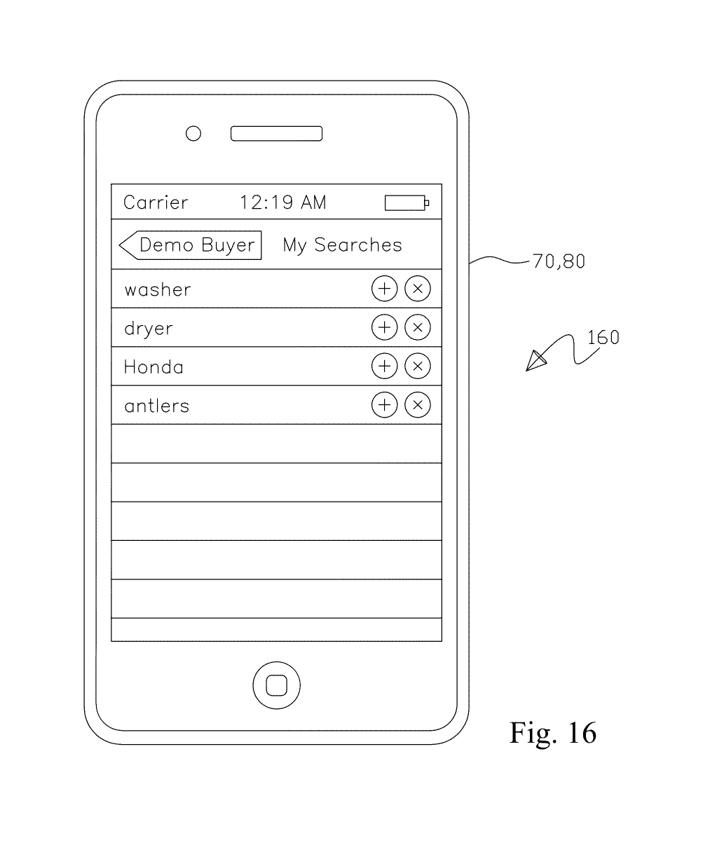

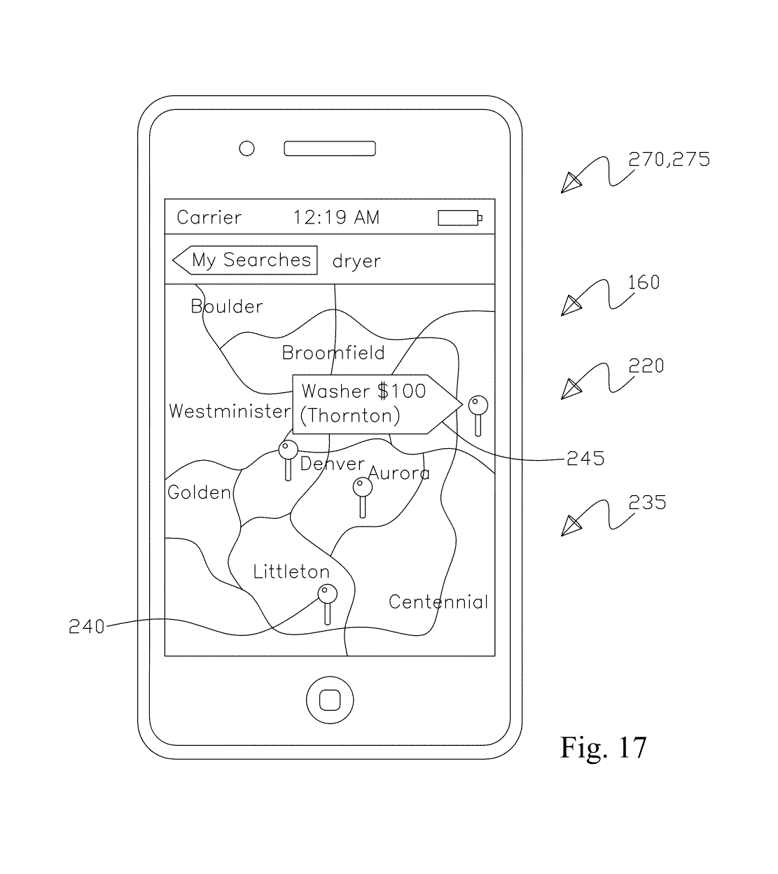

Yet further, FIG. 16 shows the location based sales system 50 sample screenshot that shows where the buyer 75 can have access to and manage their saved searches, wherein what is showing is the buyer's 75 consolidated product search results 270, 275 that are across multiple listings 70 on the web, the results are cross-referenced by sellers 60 registered in the location based sales system 50, this list is available on both the web and the mobile application device 160, wherein the mobile application device 160 also provides the added functionality of the geographic proximity alerts 220 for products to the buyer 75. Next, FIG. 17 shows the location based sales system 50 sample screenshot of a global positioning system 220 map view 235 allowing the buyer 75 to view real-time results 270, 275 and geographic location information 235 of their search results, when a buyer 75 enters a range of seller 60 products 70, the buyer 75 is notified of the geographic proximity 225 of the products 70, wherein the red balloons 240 or perceptible indication 240 indicate the product locations.

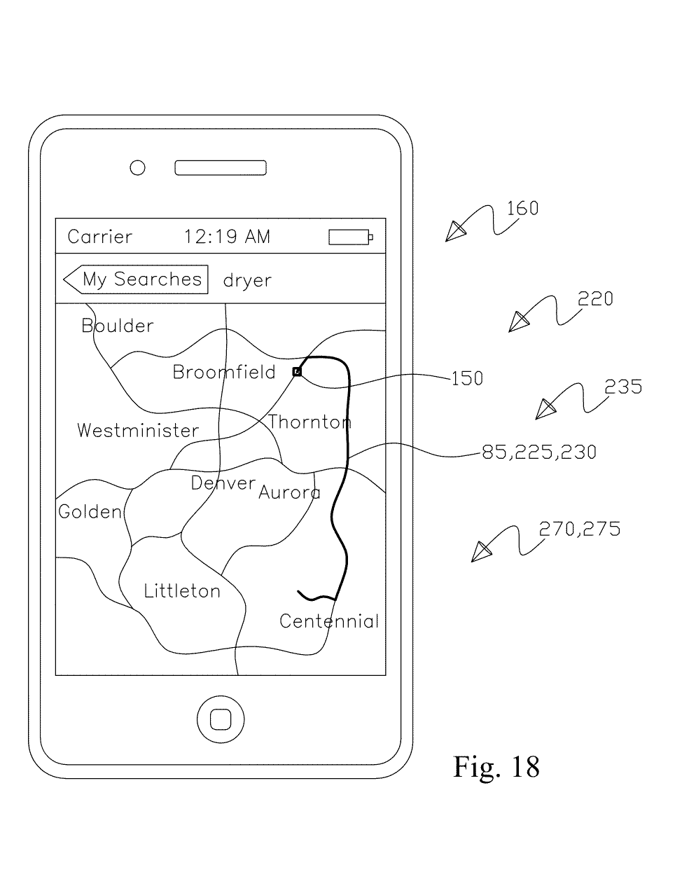

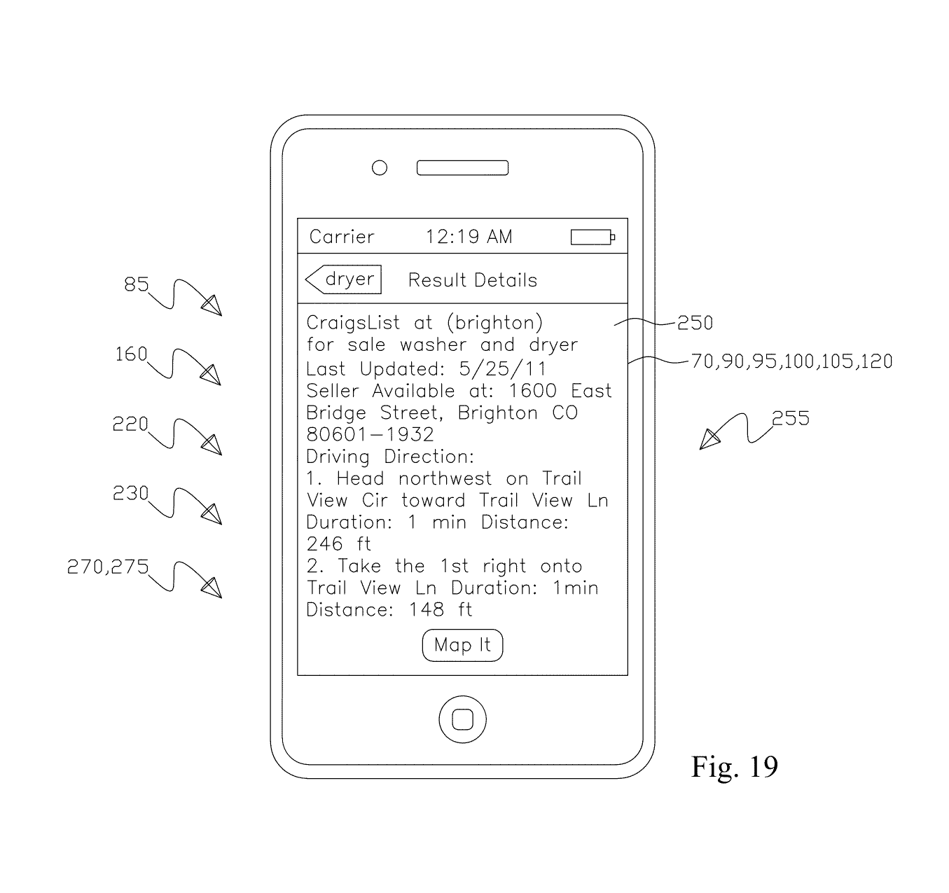

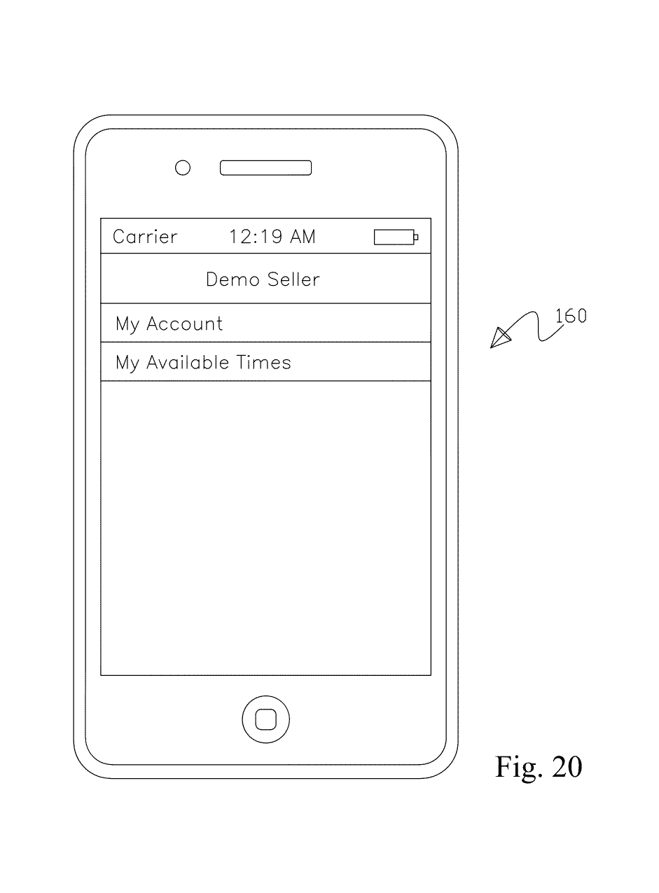

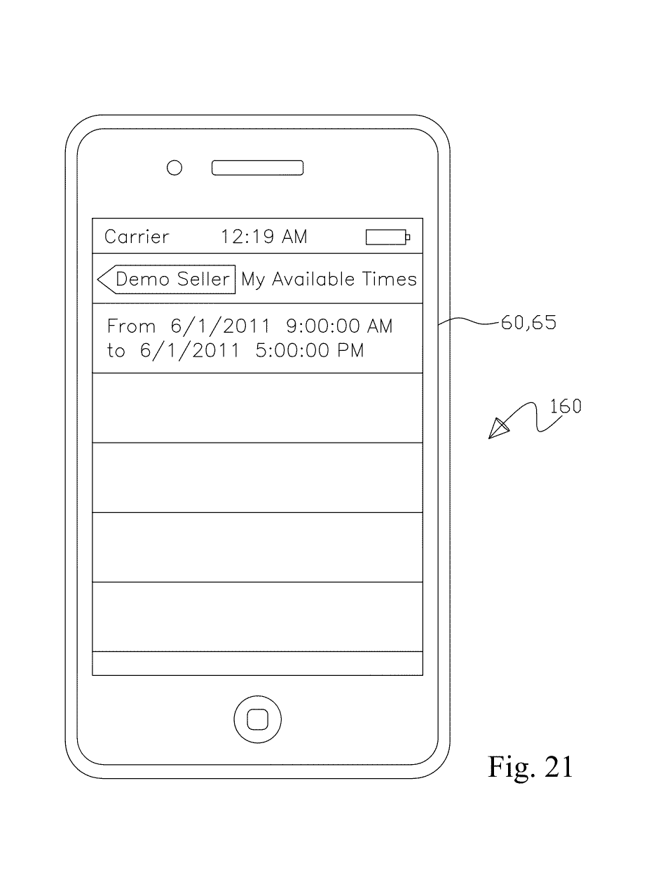

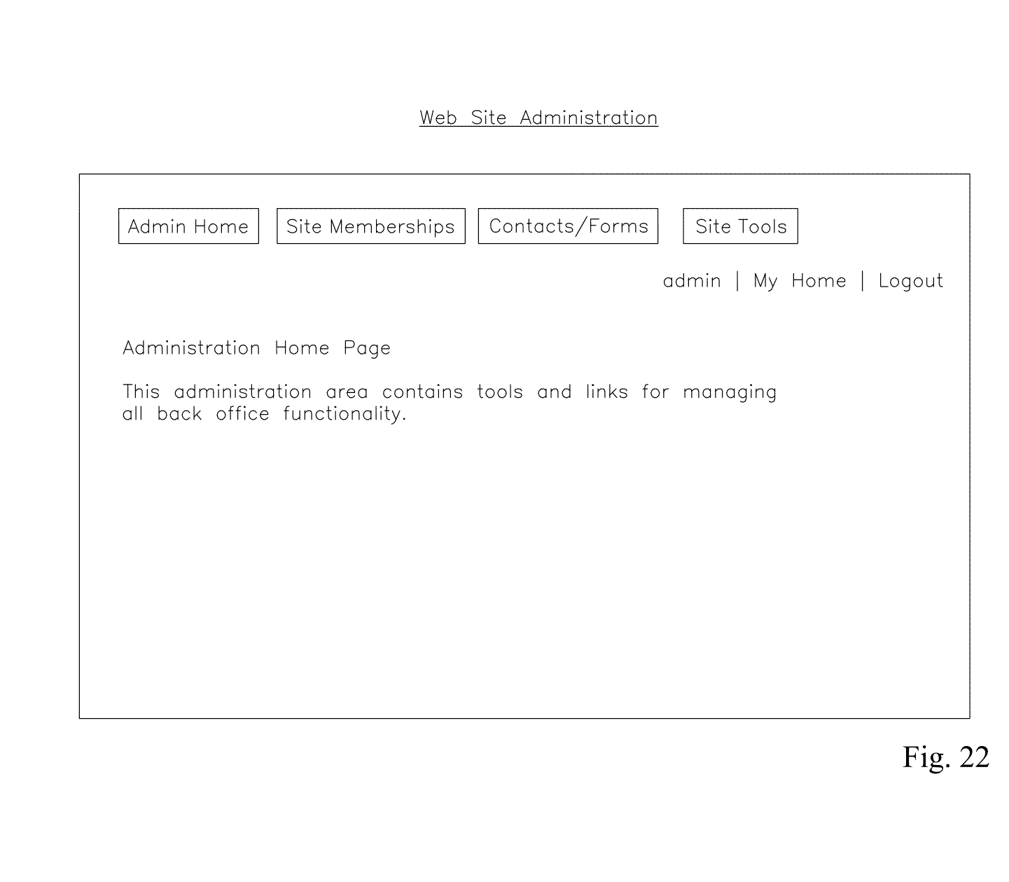

Further, FIG. 18 shows the location based sales system 50 sample screenshot of the global positioning 220 system map 235 of FIG. 17, wherein the visual driving directions 230 to a particular seller's 60 location associated with the product found in the buyers 75 search results 270, 275 are shown. Continuing, FIG. 19 shows the location based sales system 50 sample screenshot of the textual driving instructions 255 to a seller's 60 location associated with the product found in the buyers 75 search results 270, 275 that are associated with the visual driving instructions 230 shown in FIG. 18. Next, FIG. 20 shows the location-based sales system 50 sample screenshot that shows the sellers 60 ability to access the mobile device 160 to manage their account settings 65 for their products 70 offered for sale. Continuing, FIG. 21 shows the location-based sales system 50 sample screenshot of seller 60 settings 65 wherein the seller 60 can set the times they will be available to sell their products for potential buyers 75 via the global positioning system proximity alerts 220, and FIG. 22 shows a location-based sales system 50 sample screenshot of the administrator webpage wherein the administrator may manage the website, buyer 75, seller 60 membership, and system operation components.

Looking at FIGS. 1-3 and 14-21, a location-based sales system 50 is disclosed that includes a non geographically based information set 55 with a plurality of non-geographical based input characteristics that are selected from the group consisting essentially of online classifieds 70 for goods and services that are created by at least one seller 60. Further included in the location-based sales system 50 is a geographically based database 135 including a plurality of geographically based input attributes sets, wherein each set is associated with each of the online classifieds 70, each set includes geographic parameters that are selected from the group consisting essentially of zip codes, street addresses, city names, county names, state names, and geographic feature descriptors that can include items such as “flatirons”, “peninsula”, “hilltop”, “valley”, “shoreline”, “bay”, and the like that are known locally in a geographic sense. In addition, in the location-based sales system 50 is a query component 140 based upon a buyer 75 initiated search for the goods 70 or services 70 that includes a geographic tag 150 for the buyer 75, plus one or more processors 165, memory 170, and one or more programs 175, wherein the one or more programs 175 are stored in the memory 170 and configured to be executed by the one or more processors 165. The one or more programs 175 including instructions for executing the buyer 75 initiated search in the information set 55 and outputting a search result group 270, 275 that matches the buyer 75 initiated search, wherein the group 270, 275 includes at least one specific search result 270. Also, instructions to map 220 a proximate path 225 as between the buyer 75 geographic tag 150 and each one of the attribute sets 135 associated with the search result group 270, 275, wherein operationally the buyer 275 can view goods 70 or services 70 search results that include geographic mapping 235 for each specific search result 275.

The location-based sales system 50 can further comprise a seller settings array 65 that includes seller 60 settings selected from the group consisting essentially of times available, days available, payment terms, enhanced contact information, and a geographic attribute set that are included in the search result group 275, as best shown in FIGS. 5, 6, 7, and 16-19. Also, the location-based sales system 50 can further comprise a buyer criterion arrangement 80 that includes a buyer 75 criterion that is selected from the group consisting essentially of a proximate path maximum distance 85, a good type 90, a good price range 95, a good make 100, a good model 105, and a year of good manufacture 110, to more specifically define the buyer 75 desired search results 270, as best shown in FIGS. 8-12 and 17-19.

Continuing for the location-based sales system 50, it can also further comprise a buyer criterion arrangement 80 that includes buyer 75 criterion that is selected from the group consisting essentially of a proximate path maximum distance 85, a service type 115, a service price range 120, a service years in business 125, and a service specific experience 130, again as could be best shown in FIGS. 8-12 and 17-19, also as the examples are for goods (products), however, could apply equally as well to any form of services. Further, for the location-based sales system 50, wherein the instructions 210 can further comprise a priority of execution 215 as between the non geographically based information set 55 and said geographically based database 135 to generate each specific search result 270, 275 as follows; being firstly to be within the proximate path maximum distance 85, and secondly to secondly to substantially match the good 90 or service 115 type as requested by the buyer 75 in their search, thus resulting in a primary search filter based on the proximate path maximum distance 85 and then complying with the buyers 75 specific search request.

Continuing, for the location-based sales system 50 wherein the instructions 210 to map the proximate path 85 can also further comprise a mapping engine 220 that dynamically generates a visual map 235 of the specific search result 270, 275 showing a perceptible indication 240 on the visual map 235 in relation to the geographic tag 150 for the buyer 75, to give a useful display of any particular goods or services relative to the buyer 75 location 150, as best shown in FIG. 17. Further, in this area for the location-based sales system 50, wherein the perceptible indication 240 will transform into an abbreviated information box 245 upon a single command (which could be a screen touch or anything else) from the buyer 75, wherein the information box 245 includes a specific search result description, price, and location, see FIG. 17. Next, in this area for the location-based sale system 50, wherein the abbreviated information box 245 will further transform into a detailed information box 250 upon another single command from the buyer 75, wherein the detailed information box 250 includes all the input characteristics 55 and a textual rendition 255 of the proximate path 85 for instructions to proceed from the geographic tag 150 for the buyer 75 to the geographically based input attributes 135 that come from the seller 60 setting array 65, see FIG. 19.

As the location-based sales system 50 can be supplied as a disc or internet based download, there can be a computer readable storage medium (article) having stored therein instructions 210, which when executed by a computer or mobile device from a request by a buyer 75 for the selected good or service search, that can cause the computer to; process the buyer 75 criterion arrangement 80 that includes buyer criterion that is selected from the group consisting essentially of a geographic tag 150 for the buyer 75, a proximate path maximum distance 85, and a good 90, or service 115 type. Next, to access 260 a credential protected non geographically based information set 55, including a plurality of non-geographical based input characteristics that are selected from the group consisting essentially of online classifieds 70 for goods and services that are created by at least one seller 60. Continuing, to access 265 a credential protected geographically based database 135 including a plurality of geographically based input attributes sets, wherein each set is associated with each of the online classifieds 70, each set includes geographic parameters 135 that are selected from the group consisting essentially of zip codes, street addresses, city names, county names, and state names, that are created by at least one seller 60. Further, an output of at least one specific search result 270 based upon the buyer 75 criterion arrangement 80 from the non geographically based information set 55 and the geographically based database 135, wherein the specific search result 270, 275 includes the buyers 75 selected good 90 or service 115 type within the proximate path maximum distance 85 as between the buyer 75 geographic tag 150 and the geographic set 135 associated with each one of the goods or services as requested by the buyer 75.

Further, for the computer readable storage medium or article, wherein the buyer 75 criterion arrangement 80 further includes a good price range 95, a good make 100, a good model 105, and a year of good manufacture 110 that are a part of the buyer 75 criterion arrangement 80. In addition, for the computer readable storage medium article wherein the buyer 75 criterion arrangement 80 further includes a service type 115, a service price range 120, a service years in business 125, and a service specific experience 130, that are a part of the buyer 75 criterion arrangement 80. Also, for the computer readable storage medium article wherein the geographically based input set 135 further includes times available 65, days available 65, payment terms 65, enhanced contact information 65, and geographic attribute set 135 that are created by at least one seller 60. Also for the computer readable storage medium or article wherein the output 270, 275 can further comprise a priority of execution of the instructions 210 as between the non geographically based information set 55 and the geographically based database 135 to generate the specific search result 270, 275 as follows; firstly to within the proximate path maximum distance 85, and secondly to substantially match the good or service type, thus resulting in a primary search filter based on the proximate path maximum distance 85 and then complying with the buyers 75 specific search request.

### Method of Use

Looking to FIGS. 4-21, a method is disclosed for using a location-based sales system 50, with the method comprising the steps of; firstly receiving a query 140 from a buyer 75 that includes a buyer 75 criterion arrangement 80 having a geographic tag 150 for the buyer 75, a proximate path maximum distance 85, and a good 90 or service 115 type. Then, a next step of accessing 260 a credential protected non geographically based information set 55 including a plurality of non-geographical based input characteristics that are selected from the group consisting essentially of online classifieds 70 for goods and services that are created by at least one seller 60. Next, a step of accessing 265 a credential protected geographically based database 135 including a plurality of geographically based input attributes sets 135, wherein each set is associated with each of the online classifieds 70, each set includes geographic parameters 135 that are selected from the group consisting essentially of zip codes, street addresses, city names, county names, and state names, that are created by at least one seller 60. Further, a step of outputting at least one specific search result 270 based upon the buyer 75 criterion arrangement 80 from the non geographically based information set 55 and the geographically based database 135, wherein the specific search result 270 includes the buyers 75 selected good 90 or service type 115 within the proximate path maximum distance 85 as between the buyer geographic tag 150 and the geographic set 135 associated with each one of the goods or services as search requested by the buyer 75.

Further, as an option on the method for using a location-based sales system 50 wherein the receiving step buyer 75 criterion arrangement 80 further includes a good price range 95, a good make 100, a good model 105, and a year of good manufacture 110 that are a part of the buyer 75 criterion arrangement 80. Another option on the method for using a location-based sales system 50 is wherein the receiving step buyer 75 criterion arrangement 80 further includes a service type 115, a service price range 120, a service years in business 125, and a service specific experience 130 that are a part of the buyer 75 criterion arrangement 80. A next option for the method for using a location-based sales system 50 is wherein accessing 265 a credential protected geographically based database 135 step input set further includes times available 65, days available 65, payment terms 65, enhanced contact information 65, and geographic attribute set 65 that are created by at least one seller 60. Also optionally, on the method for using a location-based sales system 50 is wherein the outputting step 270, 275 further comprises a priority of execution instructions 210 as between the accessing 260 step of non geographically based information set 55 and the accessing 265 step of geographically based database 135 to generate the specific search result 270, 275 as follows; firstly to within the proximate path maximum distance 85, and secondly to substantially match the good or service type, thus resulting in a primary search filter based on the proximate path maximum distance 85 and then complying with the buyers 75 specific search request.

Incorporation by reference to the specification for the source code as follows:
Source code—concurrently submitted as an ASCII text file;
File name: LocationBasedSalesSystemSourceCodeASCIIFILES
File size (KB): 184
File creation date: Aug. 8, 2011.
File format: Plain text (.txt)
File description: Source code for the location based sales system for the mobile device.
Project name is Fish Bowl (FB) within source code.

### CONCLUSION

Accordingly, the present invention of a location-based sales system, computer readable storage medium, and method of using the same has been described with some degree of particularity directed to the embodiments of the present invention. It should be appreciated, though, that the present invention is defined by the following claims construed in light of the prior art so modifications or changes may be made to the exemplary embodiments of the present invention without departing from the inventive concepts contained therein.

1. A location-based sales system, comprising:
(a) a non geographically based information set including a plurality of non-geographical based input characteristics that are selected from the group consisting essentially of online classifieds for goods and services that are created by at least one seller;
(b) a geographically based database including a plurality of geographically based input attributes sets, wherein each said set is associated with each of said online classifieds, each said set includes geographic parameters that are selected from the group consisting essentially of zip codes, street addresses, city names, county names, state names, and geographic feature descriptors;
(c) a query component based upon a buyer initiated search for said goods or services that includes a geographic tag for the buyer;
(d) one or more processors;
(e) memory;
(f) one or more programs, wherein said one or more programs are stored in said memory and configured to be executed by said one or more processors, said one or more programs including:
(g)(i) instructions for executing said buyer initiated search in said information set and outputting a search result group that matches said buyer initiated search, wherein said group includes at least one specific search result; and
(h)(ii) instructions to map a proximate path as between said buyer geographic tag and each one of said attribute sets associated with said search result group, wherein operationally the buyer can view goods or services search results that include geographic mapping for each said specific search result.

2. A location-based sales system according to claim 1 further comprising a seller settings array that includes seller settings selected from the group consisting essentially of times available, days available, payment terms, enhanced contact information, and geographic attribute set that are included in said search result group.

3. A location-based sales system according to claim 2 further comprising a buyer criterion arrangement that includes buyer criterion that is selected from the group consisting essentially of a proximate path maximum distance, a good type, a good price range, a good make, a good model, and a year of good manufacture.

4. A location-based sales system according to claim 3 further comprising a buyer criterion arrangement that includes buyer criterion that is selected from the group consisting essentially of a proximate path maximum distance, a service type, a service price range, a service years in business, and a service specific experience.

5. A location-based sales system according to claim 4 wherein said instructions further comprise a priority of execution as between said non geographically based information set and said geographically based database to generate each said specific search result as follows;
(5)(i) firstly to within said proximate path maximum distance; and
(5)(ii) secondly to substantially match said good or service type.

6. A location-based sales system according to claim 5 wherein said instructions to map a proximate path further comprise a mapping engine that dynamically generates a visual map of said specific search result showing a perceptible indication on said visual map in relation to said geographic tag for the buyer.

7. A location-based sales system according to claim 6 wherein said perceptible indication will transform into an abbreviated information box upon a single command from the buyer, wherein said information box includes a specific search result description, price, and location.

8. A location-based sale system according to claim 7 wherein said abbreviated information box will further transform into a detailed information box upon another single command from the buyer, wherein said detailed information box includes all said input characteristics and a textual rendition of said proximate path for instructions to proceed from said geographic tag for the buyer to said geographically based input attributes.

9. A computer readable storage medium article having stored therein instructions, which when executed by a computer from a request by a buyer for a selected good or service search, cause the computer to:
(a) process a buyer criterion arrangement that includes buyer criterion that is selected from the group consisting essentially of a geographic tag for the buyer, a proximate path maximum distance, and a good or service type;
(b) access a credential protected non geographically based information set including a plurality of non-geographical based input characteristics that are selected from the group consisting essentially of online classifieds for goods and services that are created by at least one seller;
(c) access a credential protected geographically based database including a plurality of geographically based input attributes sets, wherein each said set is associated with each of said online classifieds, each said set includes geographic parameters that are selected from the group consisting essentially of zip codes, street addresses, city names, county names, and state names, that are created by at least one seller; and
(d) output at least one specific search result based upon said buyer criterion arrangement from said non geographically based information set and said geographically based database, wherein said specific search result includes the buyers selected good or service type within said proximate path maximum distance as between said buyer geographic tag and said geographic set associated with each one of said goods or services.

10. A computer readable storage medium article according to claim 9 wherein said buyer criterion arrangement further includes a good price range, a good make, a good model, and a year of good manufacture that are a part of said buyer criterion arrangement.

11. A computer readable storage medium article according to claim 9 wherein said buyer criterion arrangement further includes a service type, a service price range, a service years in business, and a service specific experience that are a part of said buyer criterion arrangement.

12. A computer readable storage medium article according to claim 9 wherein said geographically based input set further includes times available, days available, payment terms, enhanced contact information, and geographic attribute set that are created by at least one seller.

13. A computer readable storage medium article according to claim 9 wherein said output further comprises a priority of execution as between said non geographically based information set and said geographically based database to generate said specific search result as follows;
(5)(i) firstly to within said proximate path maximum distance; and
(5)(ii) secondly to substantially match said good or service type.

14. A method for using a location-based sales system, said method comprising the steps of:
(a) receiving a query from a buyer that includes a buyer criterion arrangement having a geographic tag for the buyer, a proximate path maximum distance, and a good or service type;
(b) accessing a credential protected non geographically based information set including a plurality of non-geographical based input characteristics that are selected from the group consisting essentially of online classifieds for goods and services that are created by at least one seller;
(c) accessing a credential protected geographically based database including a plurality of geographically based input attributes sets, wherein each said set is associated with each of said online classifieds, each said set includes geographic parameters that are selected from the group consisting essentially of zip codes, street addresses, city names, county names, and state names, that are created by at least one seller; and
(d) outputting at least one specific search result based upon said buyer criterion arrangement from said non geographically based information set and said geographically based database, wherein said specific search result includes the buyers selected good or service type within said proximate path maximum distance as between said buyer geographic tag and said geographic set associated with each one of said goods or services.

15. A method for using a location-based sales system according to claim 14 wherein said receiving step buyer criterion arrangement further includes a good price range, a good make, a good model, and a year of good manufacture that are a part of said buyer criterion arrangement.

16. A method for using a location-based sales system according to claim 14 wherein said receiving step buyer criterion arrangement further includes a service type, a service price range, a service years in business, and a service specific experience that are a part of said buyer criterion arrangement.

17. A method for using a location-based sales system according to claim 14 wherein said accessing a credential protected geographically based database step input set further includes times available, days available, payment terms, enhanced contact information, and geographic attribute set that are created by at least one seller.

18. A method for using a location-based sales system according to claim 14 wherein said outputting step further comprises a priority of execution as between said accessing step of non geographically based information set and said accessing step of geographically based database to generate said specific search result as follows;
(5)(i) firstly to within said proximate path maximum distance; and
(5)(ii) secondly to substantially match said good or service type.
